(19) United States
(12) Patent Application Publication
(10) Pub. No.: US 2017/0277632 A1
(43) Pub. Date: Sep. 28, 2017

(54) VIRTUAL COMPUTER SYSTEM CONTROL METHOD AND VIRTUAL COMPUTER SYSTEM

(71) Applicant: Hitachi, Ltd., Tokyo (JP)

(72) Inventors: Toshiomi MORIKI, Tokyo (JP); Naoya HATTORI, Tokyo (JP); Takayuki IMADA, Tokyo (JP)

(73) Assignee: Hitachi, Ltd., Tokyo (JP)

(21) Appl. No.: 15/505,734

(22) PCT Filed: Oct. 30, 2014
(86) PCT No.: PCT/JP2014/078984

§ 371 Date: Feb. 22, 2017

(51) Int. Cl. G06F 12/08; G06F 12/02; G06F 9/455

(52) U.S. Cl. CPC G06F 12/08; G06F 9/45558; G06F 12/0223; G06F 2009/45583; G06F 2212/652

(57) ABSTRACT

A hypervisor that allocates the computer resource of a physical computer to one or more logical partitions allocates the computer resource to be allocated to the logical partitions to the logical partitions; generates, as address conversion information, the relationship between a guest physical address and a host physical address with respect to a memory of the computer resource; enables a first address conversion portion of a processor using the address conversion information; disables the first address conversion portion after the starting of a guest OS is completed; and causes an application to be executed.

### BACKGROUND

This invention relates to a virtual computer system.

In recent years, progress of semiconductor technologies and development of process miniaturization have caused an increase in number of arithmetic cores (hereinafter referred to as “CPU core”) installed in a CPU, with some CPU products for use in a server computer having 15 or more cores per socket. In terms of one physical server, 60 CPU cores are installed in a 4-socket server, and 120 CPU cores are installed in an 8-socket server.

However, in many cases, only a single or a small number of cores are adapted to serve a user's intended usage or applications. In view of this, there is widely used logical partitioning for dividing one physical server into a plurality of logical partitions (hereinafter referred to as “LPAR”) and operating an operating system (guest OS) for each LPAR.

In addition, the progress of semiconductor technologies has resulted in production of larger-capacity memories, and a new type of database called “in-memory DB” is now drawing attention. The in-memory DB stores all pieces of DB data in a memory unlike a related-art DB, and thus can respond to a search query quickly. For this reason, the in-memory DB has realized a wide variety of searches on big data and improvement of business intelligence analyses. In the future, the in-memory DB is expected to be operated on an LPAR more frequently.

In the logical partitioning described above, a component called “hypervisor” manages computer resources such as a CPU, a memory, and an IO device, and distributes computer resources to respective LPARs. In terms of the method of distributing computer resources by the hypervisor, the computer resources are mainly classified into two types of resources as described below.

(1) Exclusive resources distributed on a space basis by, for example, an address (for example, system memory).
(2) Shared resources divided on a time basis to be used by a plurality of guest OSes (for example, legacy I/O such as a timer).

Regarding distribution of exclusive resources classified into (1) described above, a usual guest OS that is commonly used requires memory mapping that starts with a zero address when booting. Thus, at the time of logical partitioning in a server, two-stage address translation needs to be performed, including translation from a virtual address (VA) recognized by an application into a guest physical address (GPA) recognized by a guest OS (VA→GPA), and translation from the GPA into a host physical address (HPA) for designating a physical memory location of the guest physical address (GPA→HPA).

On the other hand, regarding distribution of shared resources classified into (2) described above, it is necessary to detect access to shared resources from a guest OS, and to protect a device shared by a plurality of OSes. Thus, the hypervisor detects access to an address corresponding to a shared resource and emulates read and write by the guest OS.

In access to shared resources of (2) described above, the hypervisor detects access to a specific range of guest physical addresses GPA. The hypervisor provides a function of detecting access to the specific range and then transferring control to emulation for execution. This calling function is realized by referring to a present bit (=0 or 1), which is an attribute of a specific page table that can only be controlled by the hypervisor.

A known example of the two-stage address translation of (1) described above is a function supported by hardware of the CPU (virtualization support function VT-x or the like). For example, extended page tables (EPTs) by Intel Corporation and nested page tables (NPTs) by Advanced Micro Devices, Inc. are known in x86 CPU technologies as the virtualization support function.

In the x86 CPU technologies, the translation lookaside buffer (TLB) translates a virtual address into a host physical address, but when a TLB miss has occurred, the hardware (EPT) refers to the page table to acquire a physical address to set the physical address as a translated address in the TLB.

An x64 architecture computer having a 64-bit x86 CPU (or an AMD 64 architecture computer) has an extended address space, and the EPT of the x64 architecture computer has multiple page tables of four stages. When a TLB miss has occurred in an x64 architecture computer, the EPT needs to walk the table for the guest OS such that the memory is accessed after translation into a physical address through use of a page table of the hypervisor for each stage. Thus, when the multiple page tables (PML4, PDP, PDE, PTE) each have four stages (L1 to L4), a maximum of (1+4)×4=20 times of memory access are required including translation of a start point (head address=CR3) of the page table of the guest OS.

In this case, PML4, PDP, PDE, and PTE refer to page map level 4, page directory pointer, page directory entry, and page table entry, respectively. Further, when a TLB miss has occurred in an AMD64 architecture CPU, hardware of the NPT traces the page tables of the guest OS to acquire the address of a guest space. The hardware of the NPT again traces the page tables of VMM using this address space as input, to thereby translate the address into a physical address. The hardware of the NPT writes the translated physical address into the TLB. Similarly to the EPT described above, the NPT of an AMD64 architecture computer has an overhead for address translation.

There are known paravirtualization technologies (Xen/DomU kernel) and a technology described in U.S. Pat. No. 5,077,654 B2 as a method of reducing the overhead that is caused by two-stage address translation when a TLB miss has occurred in the EPT.

In the paravirtualization technology, a memory management module of the guest OS is modified so that the guest OS can be booted even in a GPA address space that starts with a non-zero address. With this technology, the translation specifics of VA→HPA can be stored in the page table managed by the guest OS and the EPT can be disabled, to thereby achieve reduction in overhead caused by the two-stage address translation.

On the other hand, register-resident translation technologies are described in U.S. Pat. No. 5,077,654 B2, in which the CPU holds a small amount of address translation information on a register basis. The hypervisor sets the address translation information of GPA→HPA in the register, to thereby realize address translation of VA→HPA without referring to the page table of the EPT.

### SUMMARY

Reference to the page table of the EPT described above is caused when a TLB miss has occurred in the CPU. Thus, when an in-memory DB having a wide range of addresses to be referred to is operated on the LPAR, a TLB miss is likely to occur, and an overhead caused by the reference to the page table of the EPT may degrade processing performance. This also holds true for an application other than the in-memory DB, and when an application that accesses a wide range of addresses in the memory is operated on the LPAR, the processing performance may deteriorate in the same manner.

To avoid an overhead caused by the reference to the page table of the EPT, it is necessary to modify the memory management module of the guest OS or apply a register-resident translation technology to the CPU. However, a source code of the memory management module needs to be disclosed and modification thereof also needs to be allowed in order to modify the memory management module, and thus this modification cannot be applied to an OS provided in a binary form. Further, it is difficult to implement the technology of U.S. Pat. No. 5,077,654 B2 in an existing CPU such as the x64 architecture CPU or the AMD64 architecture CPU described above.

Therefore, when an x64 architecture CPU by Intel Corporation, which is an existing processor, is used and an OS whose memory management module is not allowed to be modified is used (or when an OS usable in a physical server is booted in an address space starting with 0), operation of an application having a wide range of access, for example, the in-memory DB, may degrade the processing performance.

In view of the above, it is an object of this invention to reduce an overhead caused by two-stage address translation by operating an unmodified guest OS in a virtual computer system that uses an existing CPU.

A representative aspect of the present disclosure is as follows. A method of controlling a virtual computer system in which a hypervisor is configured to allocate computer resources of a physical computer comprising a processor and a memory to one or more logical partitions and to control a guest OS and an application operating on the one or more logical partitions, the processor comprising: a first address translation module configured to translate a unique guest physical address to be allocated to the one or more logical partitions into a unique host physical address in the virtual computer system; and a second address translation module configured to translate a virtual address recognized by the application into the unique guest physical address, the method comprising: a first step of determining, by the hypervisor, a subset of the computer resources to be allocated to the one or more logical partitions to allocate the subset to the one or more logical partitions; a second step of generating, by the hypervisor, a relationship between the unique guest physical address and the unique host physical address for a memory of the subset as address translation information; a third step of enabling, by the hypervisor, the first address translation module with the address translation information; a fourth step of instructing, by the hypervisor, start of booting the guest OS; a fifth step of booting by the guest OS; a sixth step of acquiring, by the hypervisor, information on completion of the booting of the guest OS; a seventh step of disabling, by the hypervisor, the first address translation module after the completion of the booting of the guest OS; and an eighth step of starting execution by the application.

According to this invention, it is possible to reduce the overhead caused by the two-stage address translation by operating the unmodified guest OS on the hypervisor of a physical computer including the existing processor.

### BRIEF DESCRIPTION OF THE DRAWINGS

FIG. 1 is a block diagram for illustrating an example of a virtual computer system according to an embodiment.

FIG. 2 is a flowchart for illustrating an example of processing to be performed by the hypervisor according to the embodiment.

FIG. 3 is a memory map for illustrating an example of a physical address space and a virtual address space managed by the hypervisor according to the embodiment.

FIG. 4A is a diagram for illustrating an example of the resource allocation information according to the embodiment.

FIG. 4B is a diagram for illustrating an example of the LPAR attribute according to the embodiment.

FIG. 5A is a block diagram for illustrating a relationship between the guest page table managed by the guest and the virtual address according to the embodiment.

FIG. 5B is the first half of a diagram for illustrating a format of the guest page table according to the embodiment.

FIG. 5C is the second half of a diagram for illustrating a format of the guest page table according to the embodiment.

FIG. 6A is a block diagram for illustrating a relationship between the host page table managed by the hypervisor and the guest physical address according to the embodiment.

FIG. 6B is the first half of a diagram for illustrating a format of the host page table according to the embodiment.

FIG. 6C is the second half of the diagram for illustrating a format of the host page table according to the embodiment.

FIG. 7 is a flowchart for illustrating an example of processing of disabling the EPT to be performed by the hypervisor according to the embodiment.

FIG. 8 is a table for showing a register format 800 of the HPET according to the embodiment.

FIG. 9 is a screen image for illustrating an example of a configuration screen according to the embodiment.

FIG. 10 is a memory map for illustrating the physical computers and after migration of the LPAR #1 is performed according to the embodiment.

### DETAILED DESCRIPTION OF THE PREFERRED EMBODIMENTS

In the following, a description is given of an embodiment of this invention with reference to the accompanying drawings.

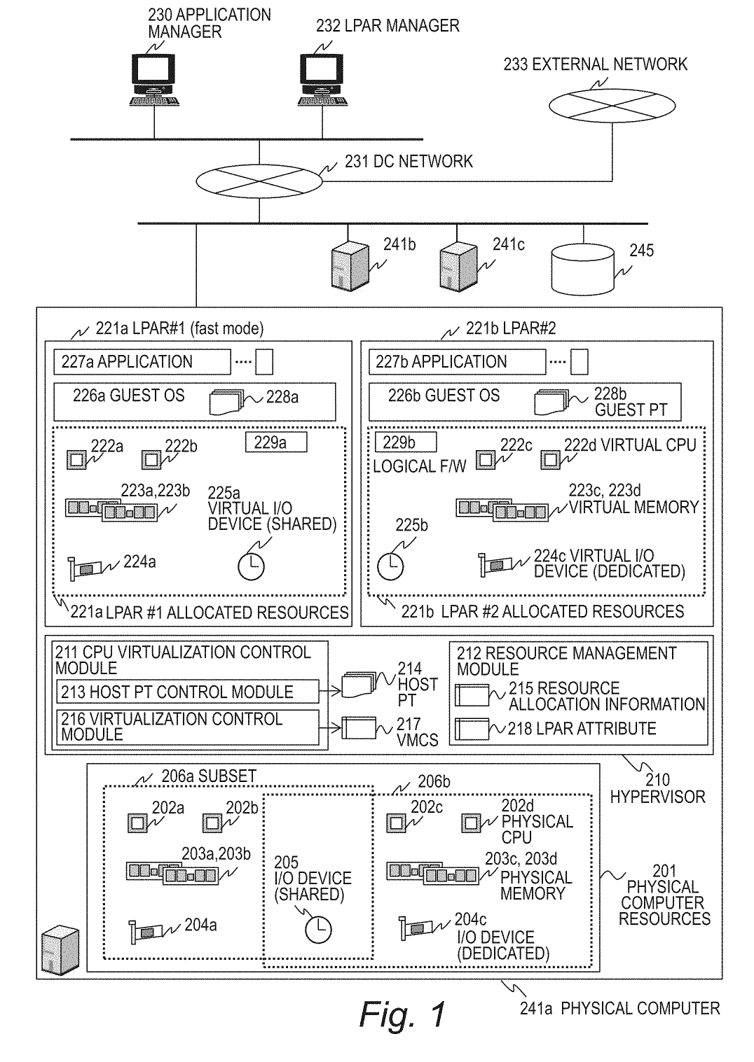

FIG. 1 is an illustration of the embodiment of this invention, and is a block diagram for illustrating an example of a virtual computer system. In physical computers 241a to 241c, guest OSes 226a and 226b configured to operate on a hypervisor 210 are provided as virtual machines. The physical computers 241a to 241c are coupled to a data center (DC in FIG. 1) network 231.

The data center network 231 is coupled to an external network 233. The guest OSes 226a and 226b or applications 227a and 227b of the physical computers 241a to 241c can be used from a computer (not shown) coupled to the external network 233.

Further, an LPAR manager 232 configured to control logical partitions (LPARs) 221a and 221b and the guest OSes 226a and 226b of the physical computers 241a to 241c, an application manager 230 configured to control the applications 227a and 227b operating on the guest OSes 226a and 226b, and a storage subsystem 245 configured to store programs and data are coupled to the data center network 231. In this case, the LPAR manager 232 and the application manager 230 are each a computer including an input device and a display device.

In the following description, the physical computers 241a to 241c are collectively denoted by a reference symbol 241 without suffixes a to c. The same holds true for other components, and the other components are also collectively denoted by a reference symbol without any suffix.

<Configuration of Computer>

Now, a description is given of the physical computers 241a to 241c for carrying out this invention with reference to FIG. 1. The physical computers 241a to 241c have the same configuration with each other, and thus only the physical computer 241a is described below.

The physical computer 241a includes, as physical computer resources 201, physical CPUs 202a to 202d, physical memories 203a to 203d, I/O devices 204a and 204c to be dedicatedly allocated to the LPARs 221, and an I/O device 205 to be shared by the plurality of LPARs 221.

The I/O devices 204a and 204c to be dedicatedly allocated are, for example, network interface cards (NICs) or host bus adapters (HBAs). Further, examples of the I/O device 205 to be shared by the plurality of LPARs 221 include a timer, for example, a high precision event timer (HPET) included in the physical computer resources 201.

The physical CPU 202a is a multicore CPU including a plurality of CPU cores in one socket, and the number of CPU cores of the physical CPUs 202b to 202d are also represented by the socket. In the following, a description is given of an example in which CPUs each having the related-art x64 architecture virtualization support function (for example, EPT) described above are adopted as the physical CPUs 202a to 202d.

In this embodiment, the physical computer resources 201 of the physical computer 241a are allocated to the two LPARs 221a and 221b. Thus, the physical computer resources 201 to be allocated to the LPAR 221a (LPAR #1) is referred to as a subset 206a and the physical computer resources 201 to be allocated to the LPAR 221b (LPAR #2) is referred to as a subset 206b.

The subset 206a includes the physical CPUs 202a and 202b, the physical memories 203a and 203b, the I/O device 204a to be dedicatedly allocated, and the I/O device 205 to be shared. The subset 206b includes the physical CPUs 202c and 202d, the physical memories 203c and 203d, the I/O device 204c to be dedicatedly allocated, and the I/O device 205 to be shared by the plurality of LPARs 221.

The hypervisor 210 is loaded onto predetermined reserved areas of the physical memories 203a to 203d to be executed by the physical CPUs 202a to 202d at a predetermined timing. The hypervisor 210 acquires the subsets 206a and 206b from the physical computer resources 201 in response to instructions from the LPAR manager 232 for allocation to the LPARs 221a and 221b. Then, the hypervisor 210 boots the guest OSes 226a and 226b in the LPARs 221a and 221b, respectively.

The guest OSes 226a and 226b of the LPARs 221a and 221b activate the applications 227a and 227b in response to instructions from the application manager 230, respectively. In this embodiment, there has been given an example in which the hypervisor 210 allocates the physical computer resources 201 to the two LPARs 221, but an arbitrary number of LPARs 221 and guest OSes 226, and an arbitrary number of applications 227 can be activated.

The respective function modules of the hypervisor 210 are loaded onto the physical memory 203 as programs to be executed by the physical CPU 202. The physical CPU 202 is configured to execute processing in accordance with the programs of the respective function modules, to thereby operate as a function module for providing predetermined functions. For example, the physical CPU 202 functions as the hypervisor 210 by executing processing in accordance with a hypervisor program. The same holds true for other programs. Further, the physical CPU 202 operates as a function module for providing respective functions of a plurality of processing to be executed by respective programs. The computer and the computer system are an apparatus and a system including those function modules, respectively.

Information such as programs and tables for implementing the respective functions of the hypervisor 210 can be stored into a storage device such as the storage subsystem 245, a non-volatile semiconductor memory, a hard disk drive, and a solid state drive (SSD), or into a non-transitory computer-readable data storage medium such as an IC card, an SD card, and a DVD.

<Configurations of Hypervisor and LPAR>

Next, the hypervisor 210 includes a CPU virtualization control module 211 configured to control execution of the guest OS 226 and the application 227, and a resource management module 212 configured to allocate the subset 206 of the physical computer resources 201 to the LPAR 221.

The resource management module 212 allocates the physical CPUs 202a and 202b of the subset 206a to the LPAR 221a as virtual CPUs 222a and 222b. The resource management module 212 allocates the physical memories 203a and 203b to the LPAR 221a as virtual memories 223a and 223b. The resource management module 212 dedicatedly allocates the I/O device 204a to the LPAR 221a. Further, the resource management module 212 allocates the physical I/O device 205 to the LPARs 221a and 221b as a virtual I/O device 225a for shared usage. Similarly, the resource management module 212 allocates the physical resources of the subset 206b to the LPAR 221b as virtualized resources.

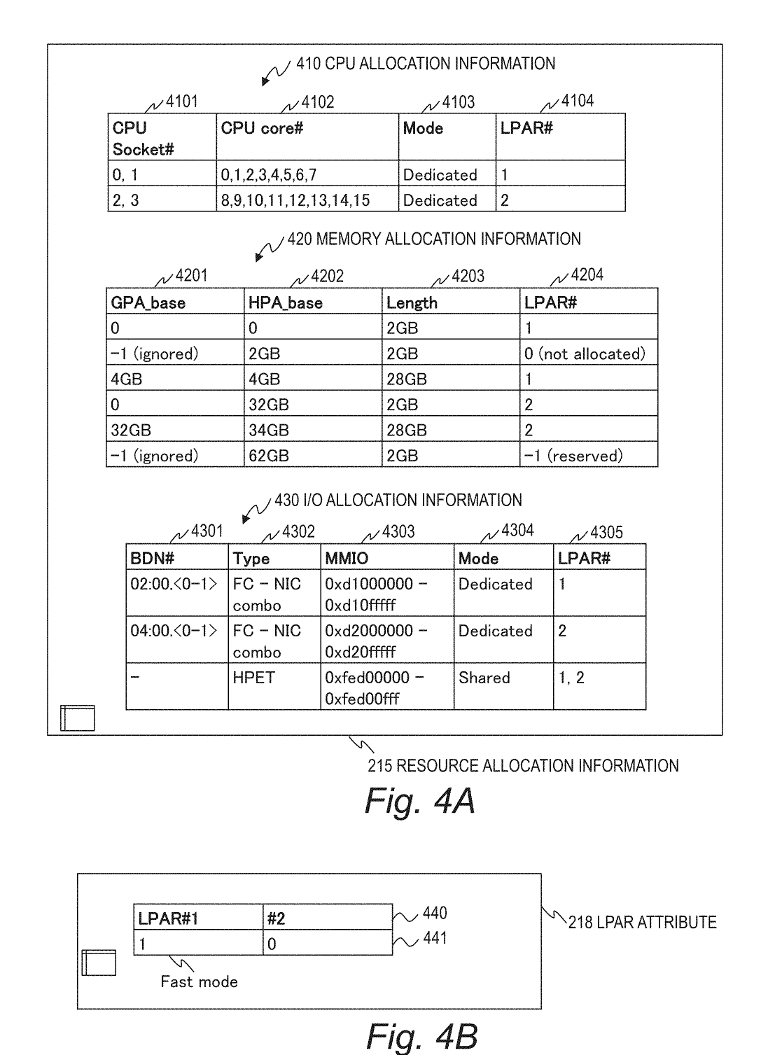

The resource management module 212 includes resource allocation information 215 (FIG. 4A) for managing virtual computer resources allocated to the physical computer resources 201 and the LPAR 221, and an LPAR attribute 218 (FIG. 4B) for managing attributes of the LPAR 221.

In this invention, the hypervisor 210 can operate any one of the LPARs 221 in a fast mode, and identifies the LPAR 221 to be operated in the fast mode with the LPAR attribute 218.

The CPU virtualization control module 211 includes a virtualization control module 216 configured to manage the guest OS 226 and the application 227 by using a virtualization support function of hardware of the physical CPU 202, and a host page table control module 213 configured to translate a guest physical address (GPA) into a host physical address (HPA) by using extended page tables (EPTs) of the virtualization support function.

The virtualization control module 216 is configured to manage the state of the hypervisor 210 and the state of the guest OS 226 or the application 227 with a virtual machine control structure (VMCS) 217 containing guest state areas and host state areas. Details of the VMCS 217 are as described in Intel™ 64 and IA-32 Architectures Software Developer Manuals (Sep. 2014, 253668-052US).

The host page table control module 213 generates and maintains the EPT described above, and the physical CPU performs address translation using guest physical addresses (GPAs) and host physical addresses (HPAs) stored in a host page table 214 (first address translation module) by the physical CPU.

Further, as described in the related-art example, when the host page table control module 213 detects access from the guest OSes 226a and 226b to the shared virtual I/O devices 225a and 225b, the host page table control module 213 performs predetermined emulation to execute an operation on the physical I/O device 205.

Specifically, the hypervisor 210 sets to “0” in the host page table 214 a presence bit of an address to which an MMIO of the shared I/O device 205 is allocated. Access from the guest OS 226 to the address results in an exception to cause VM-exit for transferring to control by the hypervisor 210. In the physical CPU 202 to which the virtualization support technology is applied, a mode for transferring to control by the hypervisor 210 is set as a VMX root mode, while a mode for transferring to control by the guest OS 226 is set as a VMX non-root mode (or guest mode).

The VM-exit is caused by an exception relating to the MMIO, and thus the virtualization control module 216 of the hypervisor 210 performs emulation in the I/O device 205. With this, the plurality of LPARs 221 are prevented from directly operating the I/O device 205 to realize sharing of the I/O device 205.

Control is transferred from the hypervisor 210 to the guest OS 226 when a VM-entry instruction is executed.

In FIG. 1, the guest OS 226a including a guest page table 228a operates in the LPAR 221a to which the hypervisor 210 has allocated the subset 206a. Then, the application 227a operates in the guest OS 226a.

The guest page table 228a (second address translation module) is configured to perform translation between a virtual address (VA) recognized by the application 227a and a guest physical address (GPA) recognized by the guest OS 226a. The guest OS 226a acquires the allocation information on the guest physical address from a logical F/W 229 (firmware: BIOS or EFI).

Similarly, the guest OS 226b including the guest page table 228b operates in the LPAR 221b to which the hypervisor 210 has allocated the subset 206b. Then, the application 227b operates in the guest OS 226b.

The host page table control module 213 of the hypervisor 210 described above generates and maintains the EPT. When the EPT of the physical CPU is valid and the host page table control module 213 receives a guest physical address (GPA) from the guest OS 226, the host page table control module 213 refers to the host page table 214 to acquire a host physical address (HPA) and realize access to the physical memory 203.

The EPT of the physical CPU 202 can be used by setting “enable EPT” of a VM-execution control field of the VMCS 217 to a predetermined value, for example, “1”. When “enable EPT” is set to “0”, the EPT is disabled.

<Address Space>

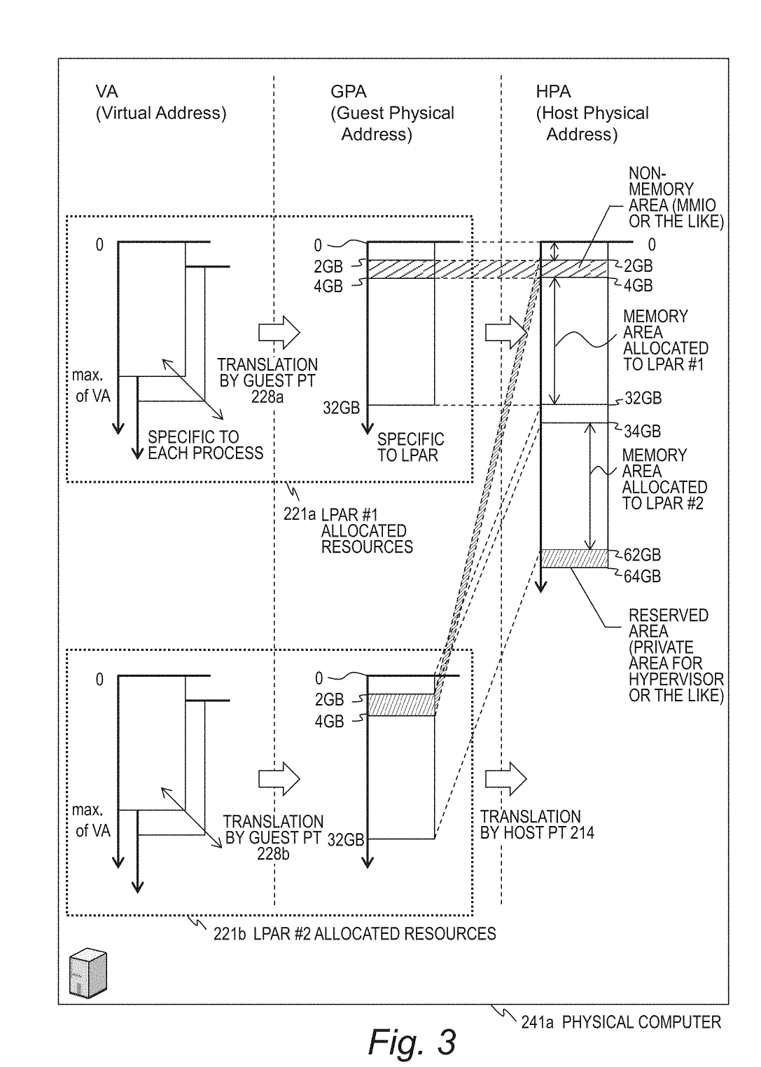

FIG. 3 is a memory map for illustrating an example of a physical address space and a virtual address space managed by the hypervisor 210. FIG. 3 is an illustration of an example of the address space of the physical computer 241a.

The hypervisor 210 allocates an area of 0 GB or higher and lower than 62 GB of host physical addresses (HPA), which is an address space of the physical memory 203, to the LPARs 221a and 221b. Further, the hypervisor 210 sets an area of 62 GB or higher and lower than 64 GB of host physical addresses as a reserved area for its own use.

The hypervisor 210 allocates an area of 2 GB or higher and lower than 4 GB of host physical addresses of the LPAR 221b to an area of 2 GB or higher and lower than 4 GB of guest physical addresses for shared usage. Regarding addresses of shared resources within the area of 2 GB or higher and lower than 4 GB of guest physical addresses, the presence bit of a host PT described later is disabled (set to 0), to thereby prohibit direct access to the shared resources.

The hypervisor 210 allocates a range of areas of 0 GB or higher and lower than 2 GB and of 4 GB or higher and lower than 32 GB of host physical addresses to the LPAR 221a. An area of 2 GB or higher and lower than 4 GB of host physical addresses is set as an I/O space (non-memory area) to be allocated to the MMIO or the like, which is a shared resource, and an example thereof is the MMIO of the I/O device 205. Regarding addresses of shared resources within the non-memory area (guest physical addresses of 2 GB or higher and lower than 4 GB) described above, the presence bit of the host PT described later is disabled (set to 0), to thereby prohibit direct access to the shared resources. Then, the hypervisor 210 allocates an area of 2 GB or higher and lower than 62 GB of host physical addresses to the LPAR 221.

Next, a range of areas of 0 GB or higher and lower than 2 GB and of 4 GB or higher and lower than 32 GB of guest physical addresses (GPA) is allocated for recognition by the guest OS 226a. The guest physical address of the guest OS 226a is the same as the host physical address. In addition, an area of 2 GB or higher and lower than 4 GB of guest physical addresses is set as an I/O space.

A range of areas of 0 GB or higher and lower than 2 GB and of 4 GB or higher and lower than 32 GB of guest physical addresses (GPA) is allocated for recognition by the guest OS 226b. The guest physical addresses of the guest OS 226b are translated in the host page table 214 into host physical addresses of 32 GB or higher and lower than 62 GB serving as terminal addresses to be used by the LPAR 221a. The shared I/O space (2 GB to 4 GB) allocated to the guest OS 226b and the guest OS 226a have the same area of 2 GB or higher and lower than 4 GB of host physical addresses.

Next, virtual addresses (VA) recognized by the application 227a of the LPAR 221a are an area allocated by the guest OS 226a of 0 or higher and lower than the maximum value. The translation between the virtual address (VA) and the guest physical address is performed by the guest page table 228a of the guest OS 226a. The virtual address recognized by the application 227b of the LPAR 221b is similar to that of the application of the LPAR 221a, and is an area allocated by the guest OS 226b of 0 or higher and lower than the maximum value.

In FIG. 3, “guest physical address=host physical address” holds true for the guest OS 226a to which host physical addresses starting with 0 have been allocated. Thus, the guest OS 226a accesses the physical memory 203 without using the host page table 214.

On the other hand, regarding the guest OS 226b, the area of host physical addresses allocated as the guest physical addresses is offset by taking the LPAR 221a into consideration. Thus, the translation between the guest physical address and the host physical address is performed using the host page table 214 of the host page table control module 213.

As described above, an address space for which the guest physical address and the host physical address are the same with each other and translation by the host page table 214 is unnecessary is allocated to the LPAR 221a. On the contrary, an address space for which translation between the host physical address and the guest physical address needs to be performed using the host page table 214 is allocated to the LPAR 221b.

As a result, the guest OS 226a and the application 227a of the LPAR 221a, to which host physical addresses starting with 0 have been allocated, can access the memory quickly with no overhead caused by the EPT of the physical CPU 202.

Further, host physical addresses of the shared I/O space (2 GB to 4 GB) are allocated to the MMIO of the physical I/O device 205 to be shared. The same guest physical address is allocated to the virtual I/O devices 225a and 225b of the respective LPARs 221a and 221b, to thereby share the I/O device 205. However, the LPAR #2 (221b) is not allowed to directly access the shared I/O device 205. This control is realized using the presence bit of the host PT (214) described later.

<Tables>

Next, a description is given of information managed by the hypervisor 210. FIG. 4A is a diagram for illustrating an example of the resource allocation information 215. The resource allocation information 215 managed by the hypervisor 210 includes three tables, namely, CPU allocation information 410, memory allocation information 420, and I/O allocation information 430.

The CPU allocation information 410 holds an allocation relationship between the physical CPU 202 and the LPAR 221. The CPU allocation information 410 contains in one entry a CPU socket#4101 for storing a socket number of the physical CPU 202, a CPU core#4102 for storing a number of the physical CPU core, a mode 4103 for storing an allocation state, and an LPAR#4104 for storing a number of the LPAR 221 to which the physical CPU 202 is allocated.

In the illustrated example, all the cores 0 to 7 of the physical CPUs 202a and 202b of socket numbers 0 and 1 are allocated to the LPAR #1 (221a), and all the cores 8 to 15 of the physical CPUs 202c and 202d of socket numbers 2 and 3 are allocated to the LPAR #2 (221b).

The memory allocation information 420 manages, for example, the LPAR 221 to which host physical addresses are allocated. The memory allocation information 420 contains in one entry a GPA_base 4201 for storing a base address of the guest physical address, an HPA_base 4202 for storing a base address of the host physical address, a length 4203 for storing the length of an allocated area, and an LPAR#4204 for storing the number of the LPAR 221 to which the host physical address is allocated. Address spaces having the host physical addresses and the guest physical addresses illustrated in FIG. 3 are given in the illustrated example.

The entry having “−1” as its GPA_base 4201 refers to an area allocated to entities other than the LPAR 221, and is, for example, a shared I/O space or a private area of the hypervisor 210.

The entry having “0” as its LPAR#4204 refers to an area to which the LPAR 221 is not allocated, and is for example, a shared I/O space. The entry having “−1” as its LPAR#4204 is a reserved area that is not allocated to the LPAR 221, and is, for example, a private area of the hypervisor 210.

The I/O allocation information 430 is information for managing the LPARs 221 to which the I/O devices 204a, 204c, and 205 of the physical computer 241a are allocated. The I/O allocation information 430 contains in one entry a BDN#4301 for storing the PCI device number of an I/O device, a type 4302 for storing a type of the I/O device, an MMIO 4303 for storing an address of the MMIO allocated to the I/O device, a mode 4304 for storing an allocation state of the I/O device, and an LPAR#4305 for storing a number of the LPAR 221 to which the I/O device is allocated.

Any one of “dedicated”, “shared”, and “unallocated” states is set as the mode 4304.

In the illustrated example, the I/O device 204a, which is dedicatedly allocated to the LPAR#4305=1 (221a), is an FC-NIC, and the I/O device 204c, which is dedicatedly allocated to the LPAR#4305=2 (221b), is an FC-NIC. Further, in the illustrated example, the HPET is a specific shared resource of the physical computer 241a, and is shared by the LPARs #1 and #2. Further, the HPET is an onboard device of the physical computer 241a, and thus the BDN#4301 takes the value of “−”.

FIG. 4B is a diagram for illustrating an example of the LPAR attribute 218. The LPAR attribute 218 contains an entry of the LPAR number 440 generated by the hypervisor 210 and an entry 441 indicating the fast mode. In the illustrated example, the LPAR #1 (221a) whose entry 441 is set to “1” operates in the fast mode. As described later, the fast mode refers to an operation mode in which the EPT is disabled to enable the guest OS 226 to directly access the host physical address. On the other hand, the LPAR 221 whose entry 441 is set to “0” operates in a normal mode in which the EPT is enabled to use the host page table 214.

In the fast mode, the host physical address corresponding to the guest physical address of the guest OS 226 can be directly accessed, but the I/O space to which shared resources are allocated is managed by the hypervisor 210. Thus, direct access from the guest OS 226 to the I/O space is restricted.

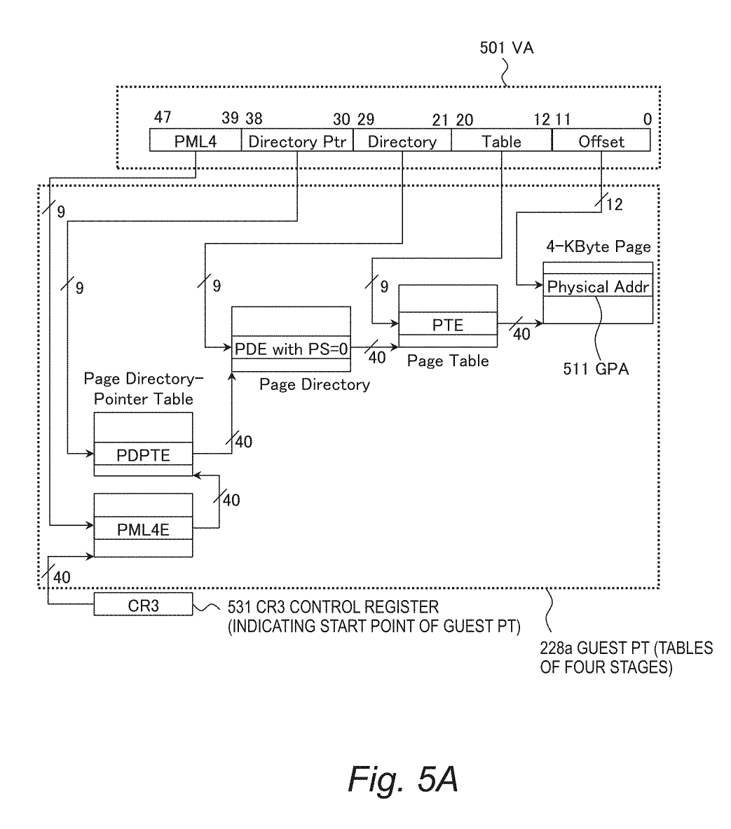

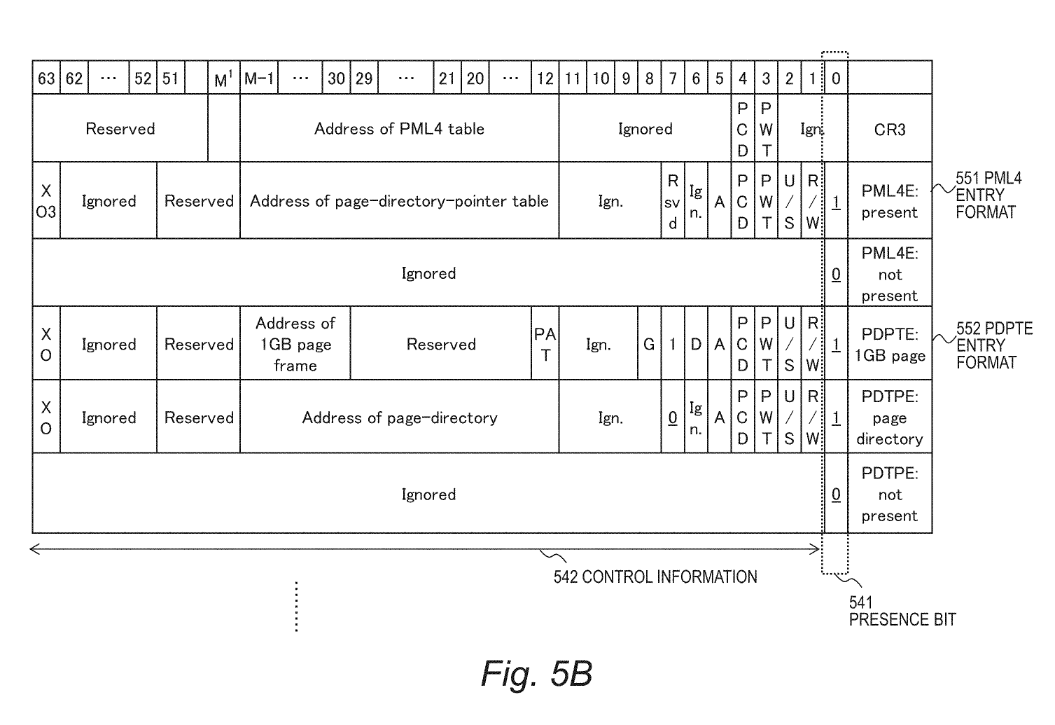

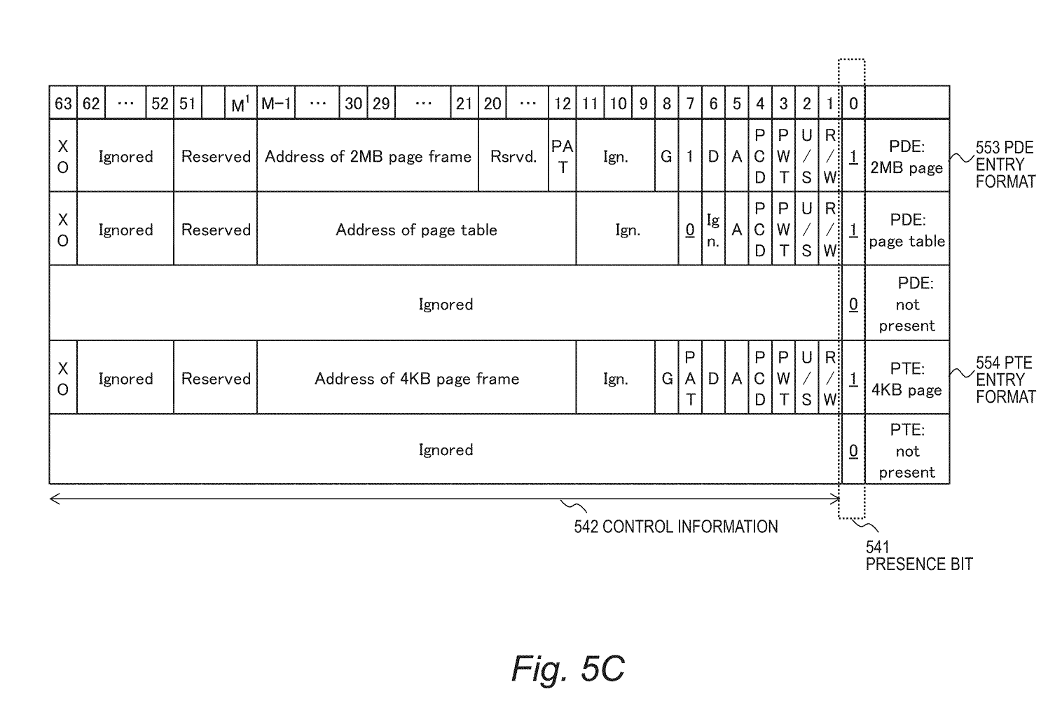

FIG. 5A is a block diagram for illustrating a relationship between the guest page table 228a managed by the guest OS 226a and the virtual address. The relationship also holds true for the guest page table 228b of the guest OS 226b, and thus a redundant description thereof is omitted here.

The illustrated example relates to a case in which an address is managed using a 4K byte page, and a virtual address (VA) 501 recognized by the application 227a is represented by 48 bits. The guest page table 228a configured to translate the virtual address (VA) 501 into a guest physical address (GPA) 511 has tables of four stages as described in the related-art example.

The guest physical address (head address) of the guest page table 228a is stored in a CR3 control register 531 in a guest state area of the VMCS 217. In the guest page table 228a, the virtual address (VA) 501 is translated into the guest physical address (GPA) 511 through use of the guest physical address serving as a start point of the guest page table 228a. The virtual address (VA) 501 contains a PML4 (Page Map Level 4) in 39th to 47th bits, a page directory pointer in 30th to 38th bits, a page directory in 21st to 29th bits, a page table in 12th to 20th bits, and an offset in 0th to 11th bits.

The guest page table 228a uses the address of the CR3 control register 531 serving as the start point to trace an entry of the PML4=page map level 4 (PML4E), an entry of the page directory pointer table (PDPTE), an entry of the page directory (PDE), and an entry of the page table (PTE), to thereby acquire the guest physical address (GPA) 511. Referring to the CR3 control register 531 and the page tables is called “nested paging”, and each table has four stages, namely, L1 to L4. Thus, as described in the related-art example, 20 times of memory access are caused when all the tables are traced.

FIG. 5B and FIG. 5C are each a diagram for illustrating a format of the guest page table 228a. A PML4 entry format 551, a PDPTE format 552, a PDE format 553, and a PTE format 554 each contain a presence bit 514 in a 0th bit and control information 542 in first to 63rd bits within 64 bits.

The presence bit 541 is set to “0” as described above, to thereby enable the hypervisor 210 to perform emulation by causing a VM-exit at the time of access from the guest OS 226. Further, an address offset, permission of read and write, and other parameters can be set to the control information 542.

The above-mentioned page mode can be enabled by a control register (not shown) for CR0.PG, CR4.PAE, and IA32_EFER.LME of the physical CPU 202.

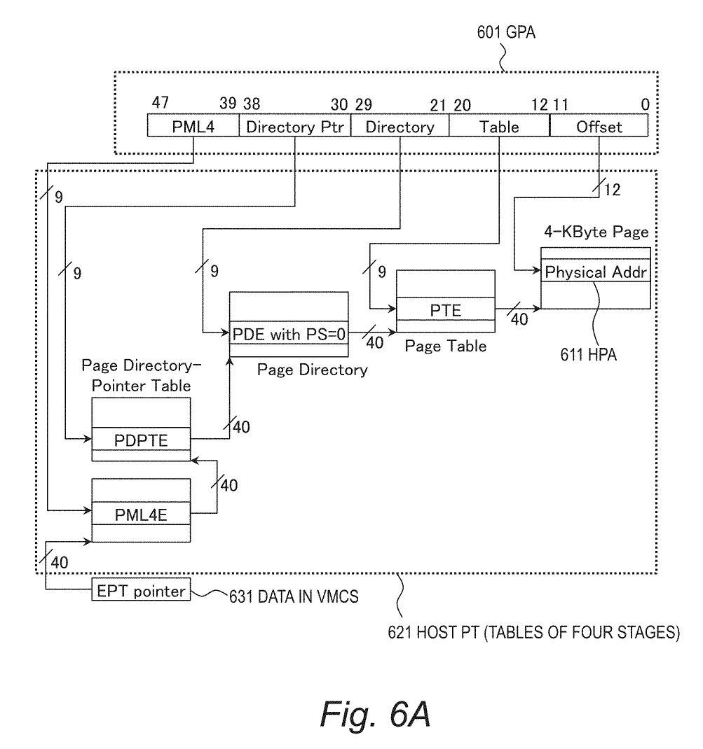

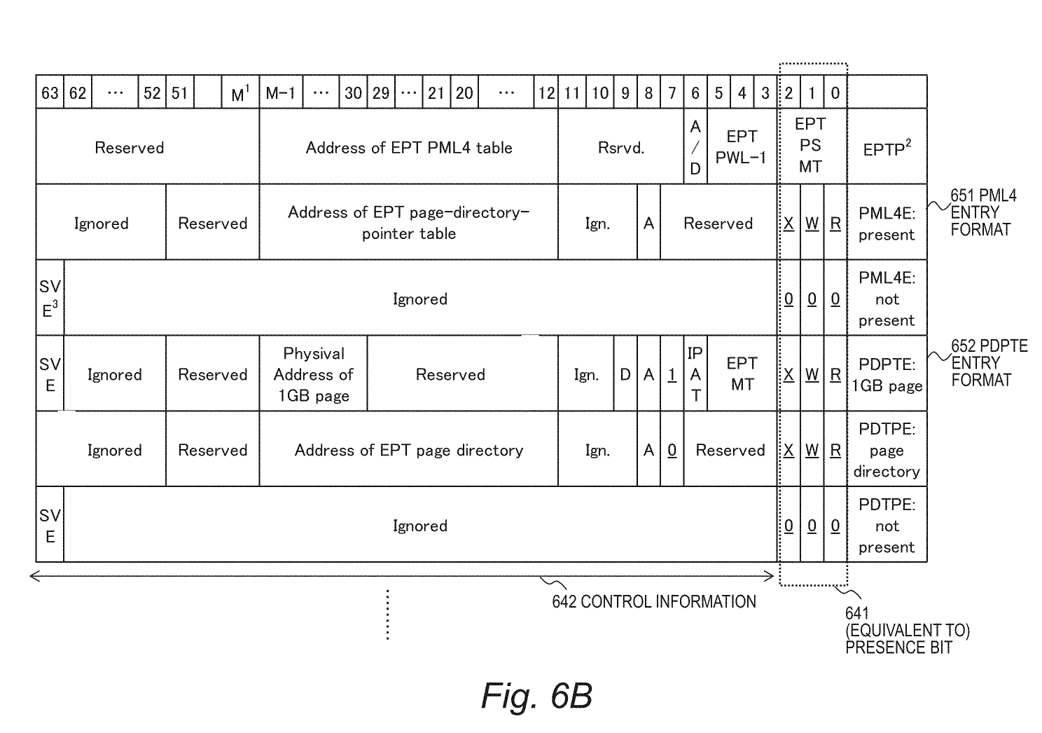

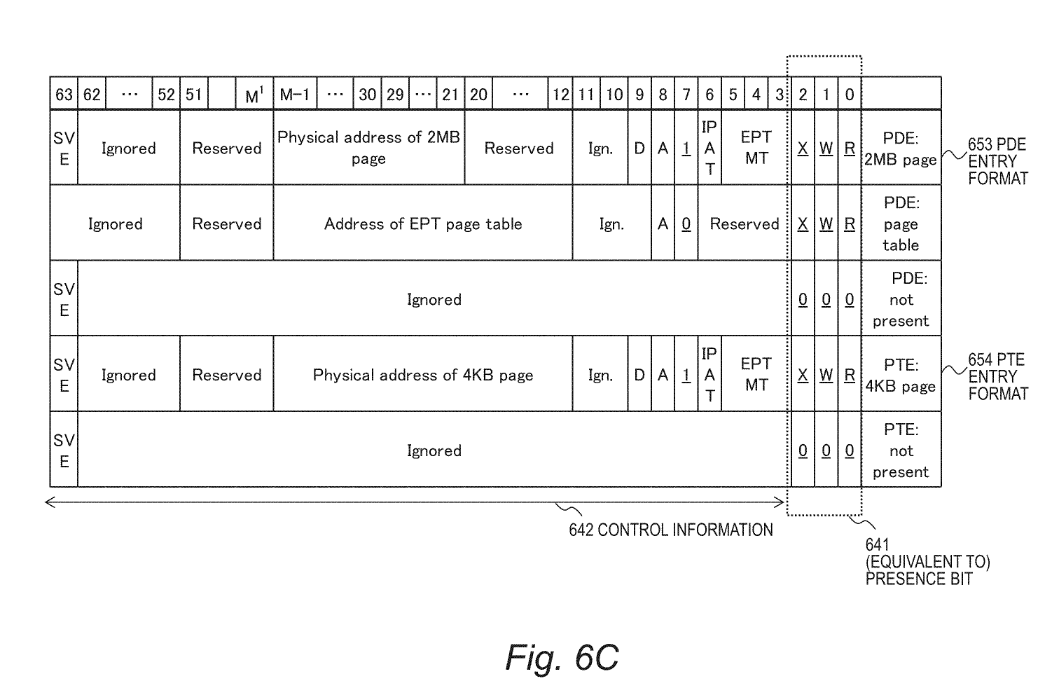

FIG. 6A is a block diagram for illustrating a relationship between the host page table 214 managed by the hypervisor 210 and the guest physical address (GPA).

In the illustrated example, an address is managed using a 4K byte page, and a guest physical address (GPA) 601 recognized by the guest OS 226a is represented by 48 bits. The host page table 214 configured to translate the guest physical address (GPA) 601 into the host physical address (HPA) 611 has tables of four stages as described in the related-art example.

The host physical address (head address) of the host page table 214 is stored in an EPT pointer in a host state area of the VMCS 217. In the host page table 214, the guest physical address (GPA) 601 is translated into the host physical address (HPA) 611 through use of the host physical address serving as a start point.

Similarly to the virtual address of FIG. 5A described above, the guest physical address (GPA) 601 contains the PML4 in 39th to 47th bits, the page directory pointer in 30th to 38th bits, the page directory in 21st to 29th bits, the page table in 12th to 20th bits, and the offset in 0th to 11th bits.

The host page table 214 uses the address of the EPT pointer serving as the start point to trace the entry of the PML4 (PML4E), the entry of the PDPT (PDPTE), the entry of the PD (PDE), and the entry of the PT (PTE), to thereby acquire the host physical address (HPA) 611. Referring to the EPT pointer and the page tables is called “nested paging” described above, and each table has four stages, namely, L1 to L4, similarly to the guest page table 228. Thus, as described in the related-art example, 20 times of memory access are caused when all the tables are traced.

FIG. 6B and FIG. 6C are each a diagram for illustrating a format of the host page table 214. A PML4 entry format 651, a PDPTE format 652, a PDE format 653, and a PTE format 654 each contain a presence bit 614 in the 0th bit and control information 642 in the first to 63rd bits within 64 bits. Those pieces of information are similar to those of the guest page table 228a illustrated in FIG. 5B and FIG. 5C.

The EPT is enabled by setting “enable EPT” of the VM-execution control field in the VMCS 217 to “1” and designating the host page table 214.

<Processing of Hypervisor>

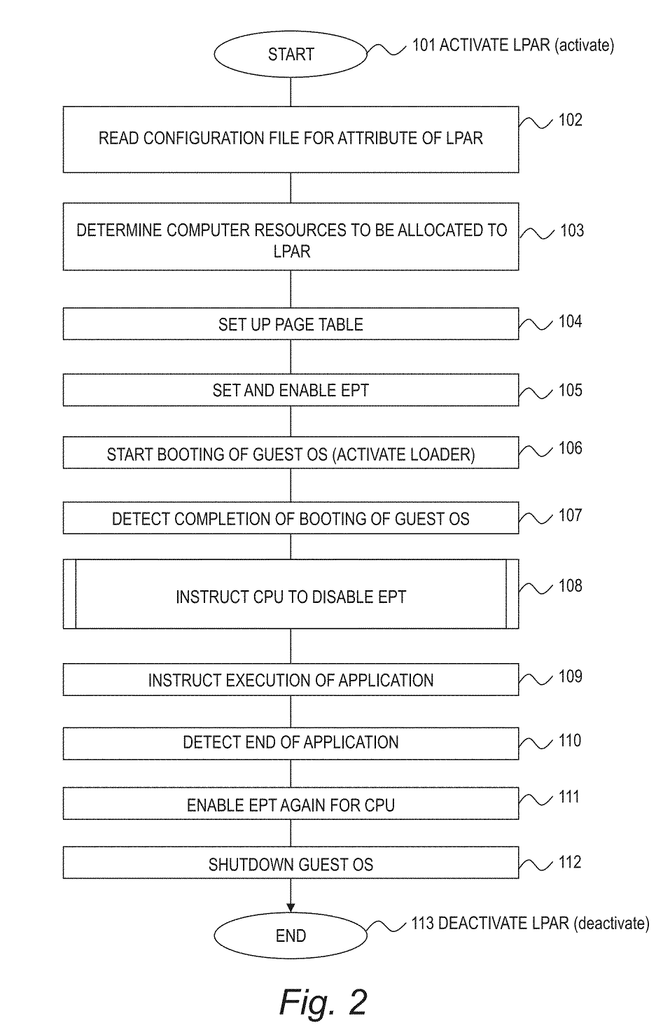

FIG. 2 is a flowchart for illustrating an example of processing to be performed by the hypervisor 210. This processing is executed when the LPAR 221 is generated or activated. For example, this processing is started when the hypervisor 210 receives a generation request (or activation request) and a configuration file for the LPAR from the LPAR manager 232 (101). In this embodiment, the configuration file contains added information, namely, information on resources necessary for the LPAR and information indicating whether the operation mode of the LPAR (LPAR attribute) is the fast mode or the normal mode.

In Step 102, the hypervisor 210 reads the configuration file to acquire information on resources necessary for the LPAR and the operation mode of the LPAR. In Step 103, the hypervisor 210 determines hardware resources and software resources based on the acquired information on resources and the operation mode. The hypervisor 210 refers to the resource allocation information 215 to determine resources to be allocated to the new LPAR among available resources.

When the hypervisor 210 performs allocation for the new LPAR and the operation mode is the fast mode, the hypervisor 210 allocates an address space whose host physical address starts with 0 to the LPAR. On the other hand, when the operation mode is the fast mode and the address space whose host physical address starts with 0 cannot be allocated, the hypervisor 210 allocates an available host physical address to the LPAR in this step.

The hypervisor 210 sets the resources allocated to the new LPAR in the resource allocation information 215, and sets the operation mode of the LPAR in the LPAR attribute 218.

Next, in Step 104, the hypervisor 210 sets a relationship between the host physical address allocated to the new LPAR and the guest physical address to the host page table 214. At this time, the hypervisor 210 generates address translation information between the guest physical address and the host physical address relating to the physical memory 203 of the subset 206 of the physical computer resources 201 to be allocated to the new LPAR, and sets this information as the page table (PTE).

Further, when the I/O device 205 is allocated to the new LPAR for shared usage, the hypervisor 210 sets the presence bit of the host physical address corresponding to the MMIO of the I/O device 205 to “0”.

Then, in Step 105, the hypervisor 210 sets “enable EPT” of the VM-execution control field of the VMCS 217 to “1” to enable the EPT by designating the host page table 214. That is, the hypervisor 210 enables the host page table 214 using the address translation information generated in Step 104.

In Step 106, the hypervisor 210 reads a boot image of the guest OS 226 from the storage subsystem 245 to boot a loader of the guest OS 226. The hypervisor 210 executes a VM-entry instruction to switch to a VMX non-root mode, and boots the guest OS 226 with the new LPAR.

The guest OS 226 generates the guest page table 228a in accordance with allocation information on system memories provided by a logical firmware 229, recognizes an area of 2 GB or higher and lower than 4 GB in the guest physical address space as an I/O space, and recognizes areas of 0 GB or higher and lower than 2 GB and of 4 GB or higher and lower than 32 GB as a system memory area.

Next, in Step 107, the hypervisor 210 determines whether or not the new LPAR has finished booting the guest OS 226. This determination is notified to the hypervisor 210 when the application manager 230 has detected completion of booting by monitoring the guest OS 226 of the physical computer 241a. When the hypervisor 210 receives this notification, the hypervisor 210 can determine that booting of the guest OS 226 is complete.

In other cases, the hypervisor 210 may detect completion of booting of the guest OS 226 by causing the booted guest OS 226 to execute a VMCALL instruction to transfer to a VMX root mode.

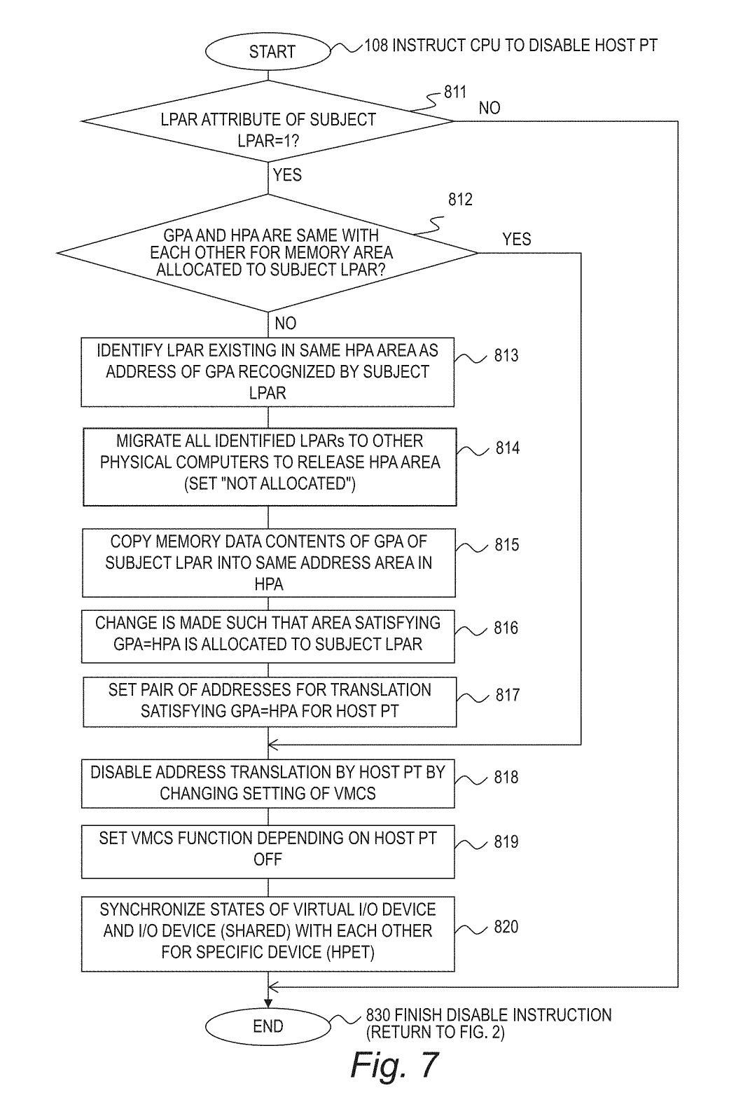

Next, in Step 108, the hypervisor 210 transfers control from the guest OS 226 to the hypervisor 210, and the hypervisor 210 disables the EPT of the physical CPU 202. First, the hypervisor 210 causes the guest OS 226 to execute a VMCALL instruction or the like to transfer to the VMX root mode. After that, the hypervisor 210 sets “enable EPT” of the VM-execution control field of the VMCS 217 to “0”. This processing is described in detail in FIG. 7.

Disabling of the EPT removes the necessity for the LPAR 221, which is in the fast mode and has the address space whose host physical address starts with 0, to translate the guest physical address into the host physical address, and thus the guest OS 226 or the application 227 can access the memory quickly. In particular, when a TLB miss has occurred, the host page table is not accessed, and thus it is possible to prevent deterioration in processing performance of the EPT as in the related-art example.

Further, the guest OS 226 is booted while the EPT is enabled, and thus the hypervisor can process (emulate) the MMIO address to the I/O device 205 to be shared. As a result, it is possible to accurately set the virtual environment of the physical computer 241 without any conflict with access from other guests.

Next, in Step 109, after the hypervisor 210 executes the VM-entry instruction to transfer to the VMX non-root mode, the guest OS 226 starts execution of the application 227 in response to an instruction from the application manager 230.

Not only the application manager 230 but also the guest OS 226 and the hypervisor 210 may instruct start of execution of the application 227.

In Step 110, the application manager 230 detects the end of the application 227 on the LPAR 221 operating in the fast mode. After the end of the application 227 on the guest OS 226, the application manager 230 causes the guest OS 226 to execute a VMCALL instruction or the like to transfer to the VMX root mode, and transfers control to the hypervisor 210.

The application 227 may notify the application manager 230 of detection of the end of the application 227 by the application manager 230 when the processing ends. In other cases, the application manager 230 may periodically monitor the end of the application 227.

Further, when control is transferred to the hypervisor 210 after the application 227 ends, the application 227 may cause the guest OS 226 to execute a VMCALL instruction or the like to transfer to the VMX root mode after the processing ends.

Next, in Step 111, the hypervisor 210 enables the EPT again. In other words, the hypervisor 210 sets “enable EPT” of the VM-execution control field of the VMCS 217 to “1”, and designates the host page table 214 to enable the EPT again.

In Step 112, the hypervisor 210 shuts down the guest OS 226 to deactivate the LPAR (113). In other words, the guest OS 226 receives a shutdown instruction from the hypervisor 210 to end its operation.

The shutdown of the guest OS 226 may be carried out in response to an instruction from the LPAR manager 232. For example, the hypervisor 210 can notify the LPAR manager 232 of the fact that the hypervisor 210 has enabled the EPT again, and the LPAR manager 232 can give a shutdown instruction to the guest OS 226 after receiving this notification.

Next, a description is given of details of disabling processing by the EPT to be performed in Step 108. FIG. 7 is a flowchart for illustrating an example of processing of disabling the EPT to be performed by the hypervisor 210.

In Step 811, the hypervisor 210 refers to the LPAR attribute 218 of a new LPAR (hereinafter referred to as “subject LPAR”), and determines whether or not the mode is the fast mode in which the entry 441 is set to “1”. The hypervisor 210 proceeds to Step 812 when the entry 441 of the LPAR attribute 218 is “1”, while the hypervisor 210 ends the flowchart of FIG. 7 when the entry 441 of the LPAR attribute 218 is “0”.

In Step 812, the hypervisor 210 determines whether or not the guest physical address (GPA) and the host physical address (HPA) allocated to the subject LPAR are the same with each other (LPAR 221a in FIG. 3). When the guest physical address and the host physical address allocated to the subject LPAR are the same with each other, the hypervisor 210 proceeds to Step 818. On the other hand, when the guest physical address and the host physical address allocated to the subject LPAR are not the same with each other, the hypervisor 210 proceeds to Step 813.

In Step 813, the hypervisor 210 identifies an LPAR existing in a host physical address (HPA) area having the same address as the guest physical address (GPA) recognized by the subject LPAR.

In other words, in a case where the LPAR attribute 218 of the subject LPAR is the fast mode, the EPT cannot be disabled when the allocated host physical address does not start with 0. Thus, the hypervisor 210 identifies another LPAR 221 that would cause duplication of addresses if host physical addresses starting with 0 were allocated to the subject LPAR.

In Step 814, the hypervisor 210 migrates the another identified LPAR to other physical computers 241b and 241c to release the host physical addresses that have been allocated to the identified LPAR. The hypervisor 210 sets the LPAR#4204 of the migrated LPAR to 0 (not allocated) in the memory allocation information 420 of the resource allocation information 215.

The hypervisor 210 may request the LPAR manager 232 to migrate the identified LPAR. In other cases, when the physical computer 241 has available resources, the physical computer 241 may perform the migration in the same physical computer 241. Further, when another physical computer 241 can allocate host physical addresses starting with 0, the LPAR to be operated in the fast mode may be migrated to another physical computer 241.

In Step 815, the hypervisor 210 copies data of the guest physical address of the subject LPAR into the released host physical address. In other words, the hypervisor 210 copies data into the same host physical address as the guest physical address of the subject LPAR. In this manner, an address space whose host physical address starts with 0 is allocated to the subject LPAR.

In Step 816, the hypervisor 210 updates the memory allocation information 420 of the resource allocation information 215. The hypervisor 210 first releases the area that has originally been allocated to the subject LPAR in the memory allocation information 420. After that, the hypervisor 210 sets the guest physical address (GPA)=host physical address (HPA) to the memory allocation information 420 as an address space that is to be allocated to the subject LPAR again. Then, the LPAR#4204 is set to the number of the subject LPAR.

In Step 817, the hypervisor 210 updates the host page table 214. The hypervisor 210 deletes the translation information (pair of GPA and HPA) that has originally been allocated to the subject LPAR out of the host page table 214. After that, the hypervisor 210 sets the guest physical address (GPA)=host physical address (HPA) in the host page table 214 as an address to be allocated to the subject LPAR again.

In Step 818, the hypervisor 210 disables address translation (EPT) by the host page table 214 by changing the setting of the VMCS 217. As described above, this specifically means that the hypervisor 210 sets “enable EPT” of the VM-execution control field of the VMCS 217 to “0”.

In Step 819, the hypervisor 210 sets the function depending on the host page table 214 off. Examples of the function depending on the host page table 214 by the VMCS 217 include VPID enable and unrestricted guest.

In Step 820, regarding the specific I/O device 205 (HPET), the hypervisor 210 synchronizes states of a virtual I/O device 204 and the specific I/O device 205 with each other. When the subject LPAR is the LPAR #1 (221a), the hypervisor 210 copies the contents of the virtual I/O device 225a serving as a shared resource into the I/O device 205 for synchronization.

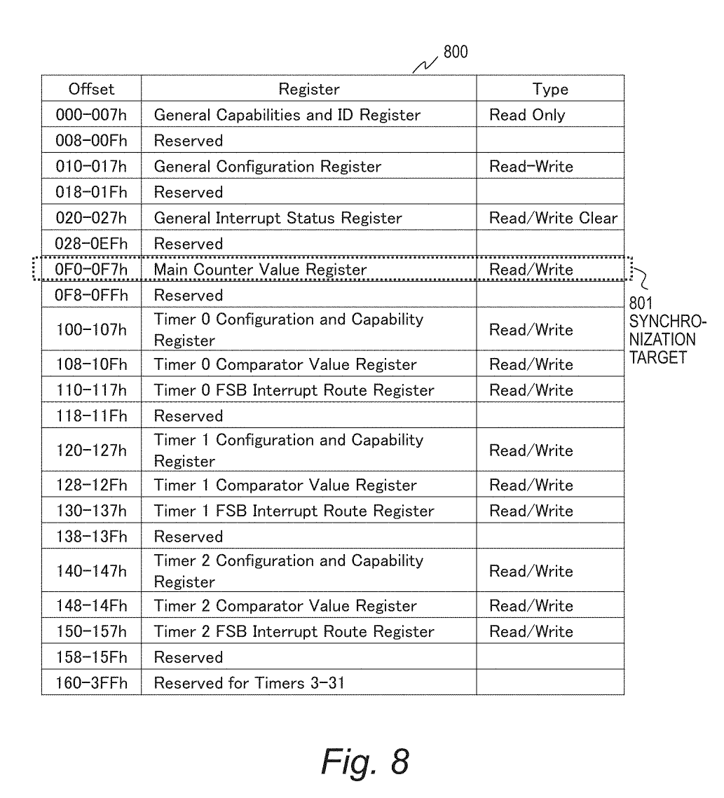

When the I/O device 205 is an HPET, as shown in FIG. 8, a main counter value register (global timer counter) of offset=0F0-0F7h is a synchronization target 801. The hypervisor 210 reads the value of the global timer counter from the virtual I/O device 225a and writes the value into the global timer counter of the I/O device 205 for synchronization. FIG. 8 is a table for showing a register format 800 of the HPET.

With the processing described above, when the LPAR attribute 218 of the LPAR to be activated is the fast mode, the guest physical address and the host physical address are allocated to the same area, and in addition, the I/O device 205 serving as a shared resource and the virtual I/O device 204 are synchronized with each other. Then, the EPT is disabled and the guest OS 226 and the application 227 are executed, to thereby avoid an overhead caused by two-stage address translation at the time of a TLB miss.

In other words, when the subject LPAR is the LPAR #1 (221a), as illustrated in FIG. 3, the guest physical address and the host physical address are mapped to the same address space. Thus, even when the EPT is disabled, the guest OS 226a can access the host physical address. Further, the host physical address starts with 0, and thus it is possible to employ an OS that can be booted on the physical computer 241 as the guest OS 226. Therefore, there is no need for modification of the OS as in the related-art example.

Further, in the physical computer 241, the EPT only needs to be disabled with the x64 architecture physical CPU 202. Therefore, there is no need to incorporate a particular component into the CPU as in the technology of U.S. Pat. No. 5,077,654 B2, and a physical CPU having an existing x64 architecture can be employed.

Further, when host physical addresses starting with 0 have already been allocated to another LPAR at the time of activation of the subject LPAR, another LPAR with the allocated host physical addresses starting with 0 is migrated. After that, host physical addresses starting with 0 are allocated to the subject LPAR. With this, it is possible to allocate host physical addresses starting with 0 to the subject LPAR even when the host physical address of 0 has already been allocated to another LPAR, to thereby activate the guest OS 226 and the application 227 in the fast mode in which the EPT is disabled.

For example, when the LPAR #2 (221b) illustrated in FIG. 3 is the fast mode, the hypervisor 210 migrates the LPAR #1 (221a) with the allocated host physical addresses starting with 0 of the physical computer 241a to the physical computer 241b. Then, the hypervisor 210 releases the host physical addresses that have been allocated to the LPAR #1.

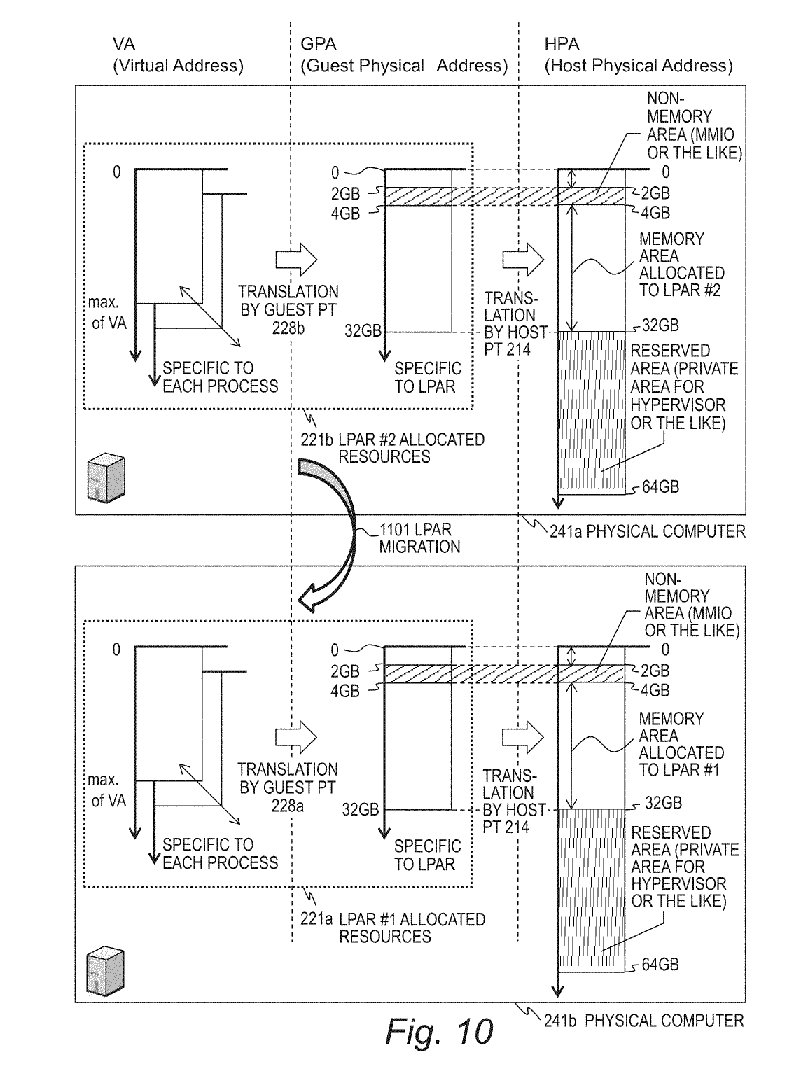

Next, contents of 32 GB or higher and lower than 62 GB of the LPAR #2 (221b) illustrated in FIG. 3 are copied into areas of 0 GB or higher and lower than 2 GB and of 4 GB or higher and lower than 32 GB of host physical addresses as illustrated in FIG. 10. Further, contents of the virtual I/O device 225b shared by the LPAR #2 (221b) are copied into the I/O device 205. FIG. 10 is a memory map for illustrating the physical computers 241a and 241b after migration 1101 of the LPAR #1 is performed.

With this, it is possible to allocate resources of the physical computer 241a to the LPAR #2 (221b) in the fast mode, and to operate the guest OS 226a and the application 227a in the fast mode in which the EPT is disabled.

Further, when execution of the application 227a is finished in an LPAR in the fast mode, the hypervisor 210 enables the EPT again. With this, another LPAR #2 can perform the two-stage address translation using the host page table 214.

In this embodiment, an example of migrating the LPAR #1 is illustrated, but a method of migrating the LPAR #2 is also conceivable. A person skilled in the art can easily conceive both methods, and thus those methods are included in the scope of this invention.

<Setting of LPAR>

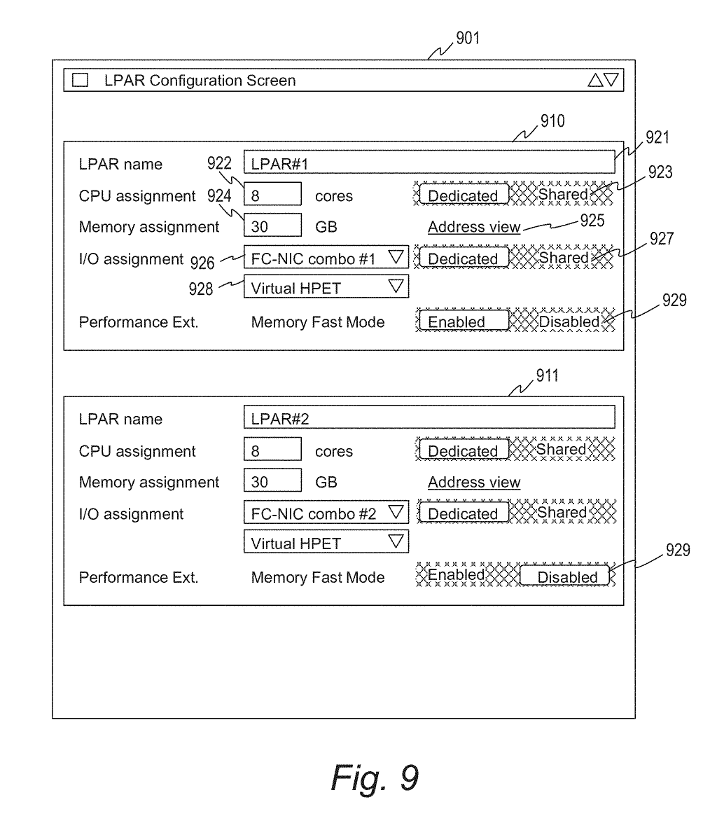

An example of the screen for configuring the LPARs 221a and 221b illustrated in FIG. 3 is illustrated in FIG. 9. FIG. 9 is a screen image for illustrating an example of a configuration screen 901 for the LPARs 221a and 221b. This screen image is output to, for example, a display apparatus of the LPAR manager 232. The user of the LPAR manager 232 determines necessary resources for the LPAR in the configuration screen, and can transmit the necessary resources to the hypervisor 210 of the physical computer 241 as a configuration file.

The configuration screen 901 includes areas 910 and 911 for the LPAR #1 (221a) and the LPAR #2 (221b), respectively. The number, identifier, or the name of the LPAR is input to an LPAR name 921.

The number of physical CPU cores to be allocated to the subject LPAR is input to a CPU allocation 922. An allocation switch 923 is set to determine whether allocated physical CPU cores of the CPU allocation 922 are to be dedicated or shared.

The capacity of memories to be allocated to the subject LPAR is input to a memory allocation 924. An address view 925 is a hyperlink for displaying an address map (GPA-HPA) on a separate screen.

An I/O allocation 926 is a drop-down menu for selecting an I/O device to be allocated to the subject LPAR. An allocation switch 927 is set to determine whether an allocated I/O device selected with the I/O allocation 926 is to be dedicated or shared.

A shared resource allocation 928 is a drop-down menu for selecting a specific shared resource (for example, HPET) of the physical computer 241a.

A performance extension 929 is set to determine whether the subject LPAR is to be operated in the fast mode or in the normal mode. The performance extension 929 is exclusive, and when one LPAR is set to “Enabled”, another LPAR is set to “Disabled” as in the LPAR #2 (911). The area 911 of the LPAR #2 is formed in the same manner as the above-mentioned area 910.

### SUMMARY

As described above, in this invention, resources are allocated to LPARs under the state in which the EPT is enabled, and the host page table 214 and shared resources are initialized to construct a virtual environment. At this time, host physical addresses starting with 0 are allocated to an LPAR in the fast mode. Then, through execution of the application 227 by the LPAR in the fast mode after the EPT is disabled, the guest OS 226 does not need to perform the two-stage address translation as in the related-art example, to thereby achieve higher processing performance.

Further, the guest OS 226 does not need to be modified as in the related-art example, and an x64 architecture physical CPU can be used, to thereby achieve reduction in overhead caused by two-stage address translation by operating the guest OS 226 on the hypervisor 210 of the physical computer 241 including an existing CPU.

Further, when execution of the application 227 by an LPAR in the fast mode is complete, the hypervisor 210 enables the EPT again, and thus it is possible to return to the usual virtual environment.

In this embodiment, a description has been given of an x64 architecture physical CPU, but an AMD64 architecture physical CPU may be used instead. In this case, the x64 architecture EPT only needs to be replaced with the AMD64 architecture NPT.

Further, in this embodiment, an example has been described in which the physical CPU 202 is a multicore CPU, but the physical CPU 202 may be a heterogeneous multi core processor.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

<Supplementary Note>

16. The virtual computer system according to claim 10,

in which the virtual computer system further includes an application manager configured to manage start and end of the execution of the application,

in which the application manager is configured to detect the completion of the booting of the guest OS to notify the hypervisor of the completion of the booting of the guest OS, and

in which the hypervisor is configured to receive the notification to disable the first address translation module.

17. The virtual computer system according to Supplementary Note 16, in which the hypervisor is configured to, when the hypervisor receives the notification to disable the first address translation module:

determine whether or not values of the unique guest physical address and the unique host physical address, which are a pair of addresses set to the first address translation unit, are the same with each other;

newly secure, when it is determined that the values are not the same with each other, a memory area of a host physical address that is the same as the unique guest physical address;

copy data of the subset of a memory allocated to the one or more logical partitions into the newly secured memory area; and

set the same value as the unique guest physical address to the unique host physical address for the first address translation unit.

18. The virtual computer system according to Supplementary Note 17, in which the hypervisor is configured to, when it is determined that the values are not the same with each other and the hypervisor newly secures the memory area of the host physical address that is the same as the unique guest physical address:

determine whether or not a memory area to be secured is already allocated to another logical partition; and

migrate, when it is determined that the memory area to be secured is already allocated, the another logical partition to another physical computer.

What is claimed is:

1. A method of controlling a virtual computer system in which a hypervisor is configured to allocate computer resources of a physical computer comprising a processor and a memory to one or more logical partitions and to control a guest OS and an application operating on the one or more logical partitions,
the processor comprising:
a first address translation module configured to translate a unique guest physical address to be allocated to the one or more logical partitions into a unique host physical address in the virtual computer system; and
a second address translation module configured to translate a virtual address recognized by the application into the unique guest physical address,
the method comprising:
a first step of determining, by the hypervisor, a subset of the computer resources to be allocated to the one or more logical partitions to allocate the subset to the one or more logical partitions;
a second step of generating, by the hypervisor, a relationship between the unique guest physical address and the unique host physical address for a memory of the subset as address translation information;
a third step of enabling, by the hypervisor, the first address translation module with the address translation information;
a fourth step of instructing, by the hypervisor, start of booting the guest OS;
a fifth step of booting by the guest OS;
a sixth step of acquiring, by the hypervisor, information on completion of the booting of the guest OS;
a seventh step of disabling, by the hypervisor, the first address translation module after the completion of the booting of the guest OS; and
an eighth step of starting execution by the application.

2. The method of controlling a virtual computer system according to claim 1, further comprising:
a ninth step of detecting, by the hypervisor, end of the application;
a tenth step of enabling, by the hypervisor, the first address translation module again; and
an eleventh step of ending by the guest OS when receiving a shutdown instruction.

3. The method of controlling a virtual computer system according to claim 1, wherein the second step comprises generating, as the address translation information, a pair of addresses in which the unique guest physical address and the unique host physical address take the same value with each other.

4. The method of controlling a virtual computer system according to claim 1,
wherein the physical computer further comprises a physical I/O device mapped to a predetermined host physical address,
wherein the first step comprises mapping a virtual I/O device to a guest physical address having the same number as a number of the physical I/O device and allocating the virtual I/O device to the one or more logical partitions, and
wherein the seventh step comprises setting a state already set to the virtual I/O device to the physical I/O device.

5. The method of controlling a virtual computer system according to claim 4,
wherein the physical I/O device comprises a high precision event timer comprising a global timer counter, and the virtual I/O device comprises a virtual high precision event timer comprising a global timer counter, and
wherein the seventh step comprises acquiring, by the hypervisor, a value of the global timer counter of the virtual high precision event timer to set the global timer counter of the high precision event timer to the value.

6. The method of controlling a virtual computer system according to claim 1,
wherein the processor is configured to conform to one of an extended page table (EPT) specified by a CPU by Intel Corporation and a nested page table (NPT) specified by a CPU by Advanced Micro Devices, Inc., and
wherein the third step comprises designating a host page table corresponding to one of the EPT and the NPT.

7. The method of controlling a virtual computer system according to claim 1,
wherein the virtual computer system further comprises an application manager configured to manage start and end of the execution of the application, and
wherein the seventh step comprises:
detecting, by the application manager, the completion of the booting of the guest OS to notify the hypervisor of the completion of the booting of the guest OS; and
receiving, by the hypervisor, the notification to disable the first address translation module.

8. The method of controlling a virtual computer system according to claim 7, wherein the receiving, by the hypervisor, the notification to disable the first address translation module comprises:
determining, by the hypervisor, whether or not values of the unique guest physical address and the unique host physical address, which are a pair of addresses set to the first address translation unit, are the same with each other;
newly securing, by the hypervisor, when it is determined that the values are not the same with each other, a memory area of a host physical address that is the same as the unique guest physical address;
copying, by the hypervisor, data of the subset of a memory allocated to the one or more logical partitions into the newly secured memory area; and
setting, by the hypervisor, the same value as the unique guest physical address to the unique host physical address for the first address translation unit.

9. The method of controlling a virtual computer system according to claim 8, wherein the newly securing, by the hypervisor, when it is determined that the values are not the same with each other, a memory area of a host physical address that is the same as the unique guest physical address comprises:
determining whether or not a memory area to be secured is already allocated to another logical partition; and
migrating, when it is determined that the memory area to be secured is already allocated, the another logical partition to another physical computer.

10. A virtual computer system, comprising:
a physical computer comprising a processor and a memory;
a hypervisor configured to allocate computer resources of the physical computer to one or more logical partitions; and
a guest OS and an application configured to operate on the one or more logical partitions,
the processor comprising:
a first address translation module configured to translate a unique guest physical address to be allocated to the one or more logical partitions into a unique host physical address in the virtual computer system; and
a second address translation module configured to translate a virtual address recognized by the application into the unique guest physical address,
wherein the hypervisor is configured to:
determine a subset of the computer resources to be allocated to the one or more logical partitions to allocate the subset to the one or more logical partitions;
generate a relationship between the unique guest physical address and the unique host physical address for a memory of the subset as address translation information;
enable the first address translation module with the address translation information;
instruct start of booting the guest OS to boot the guest OS;
acquire information on completion of the booting of the guest OS to disable the first address translation module after the completion of the booting of the guest OS; and
cause the application to start execution.

11. The virtual computer system according to claim 10,
wherein the hypervisor is configured to enable the first address translation module again after detecting end of the application, and
wherein the guest OS is configured to end when receiving a shutdown instruction.

12. The virtual computer system according to claim 10, wherein the hypervisor is configured to generate, as the address translation information, a pair of addresses in which the unique guest physical address and the unique host physical address take the same value with each other.

13. The virtual computer system according to claim 10,
wherein the physical computer further comprises a physical I/O device mapped to a predetermined host physical address; and
wherein the hypervisor is configured to:
map a virtual I/O device to a guest physical address having the same number as a number of the physical I/O device and allocate the virtual I/O device to the one or more logical partitions; and
set a state already set to the virtual I/O device to the physical I/O device.

14. The virtual computer system according to claim 13,
wherein the physical I/O device comprises a high precision event timer comprising a global timer counter, and the virtual I/O device comprises a virtual high precision event timer comprising a global timer counter, and
wherein the hypervisor is configured to acquire a value of the global timer counter of the virtual high precision event timer to set the global timer counter of the high precision event timer to the value.

15. The virtual computer system according to claim 10,
wherein the processor is configured to conform to one of an extended page table (EPT) specified by a CPU by Intel Corporation and a nested page table (NPT) specified by a CPU by Advanced Micro Devices, Inc., and
wherein the hypervisor is configured to designate a host page table corresponding to one of the EPT and the NPT.
